(19) United States
(12) Patent Application Publication
(10) Pub. No.: US 2023/0097897 A1
(43) Pub. Date: Mar. 30, 2023

(54) Automated Model Selection

(71) Applicant: Etsy, Inc., Brooklyn, NY (US)

(72) Inventors: Luis F. Campos, Brooklyn, NY (US); Vin Tang, Brooklyn, NY (US); Ercan Yildiz, Brooklyn, NY (US)

(21) Appl. No.: 17/832,415

(22) Filed: Jun. 3, 2022

Related U.S. Application Data
(60) Provisional application No. 63/251,000, filed on Sep. 30, 2021.

(51) Int. Cl. G06N 5/02

(52) U.S. Cl. CPC G06N 5/022

(57) ABSTRACT

Methods, systems, and apparatus, including computer programs encoded on a computer storage medium, for evaluating and comparing multiple trained machine learning models. Methods can include generating, using a first and a second machine learning model, a respective predicted value for the target attribute. The methods compute a differential value for a model performance metric indicating a difference in the respective model performance attribute values and a corresponding confidence interval that indicates a probability that the differential value accurately reflects the difference in the respective model performance attribute values using a linear regression model and the respective predicted values. The methods then select based on the computed confidence interval a machine learning model. The methods obtain a set of actual data items encountered in a production environment, and use the selected machine learning model to generate a corresponding set of predicted values for the target attribute.

### BACKGROUND

This specification relates to efficient selection of a machine learning model from among multiple machine learning models.

Machine learning is a type of artificial intelligence that aims to teach computers how to learn and act without necessarily being explicitly programmed. More specifically, machine learning is an approach to data analysis that involves building and adapting models, which allow computer executable programs to “learn” through experience. Machine learning involves design of algorithms that adapt their models to improve their ability to make predictions. The computer may identify rules or relationships during the training period and learn the learning parameters of the machine learning model. Then, using new inputs, the machine learning model can generate a prediction based on the identified rules or relationships. Machine learning can be applied to a variety of areas such as search engines, medical diagnosis, natural language modelling, autonomous driving etc.

The process of finding a solution to a problem using machine learning involves not just building a predictive model but also involves other steps such as defining a problem statement, data gathering and sampling, data preparation, data exploration, building a model, model configuration and model evaluation etc. In general, given a particular problem statement, multiple machine learning algorithms can be used to model the data where each machine learning algorithm can be configured based on multiple design choices.

As used in this document, the following terms have the following meanings, unless the context of use suggests otherwise. The following definitions are explained with reference to a binary classification model that predicts whether the input to the binary classification model belongs to a “positive” or a “negative” class. The results of such a binary classification model can be expressed using the following table

| | | True Classes | |
|---|---|---|---|
| | | Positive | Negative |
| Predicted | Positive | True Positive | False Positive |
| Classes | | (TP) | (FP) |
| | Negative | False Negative | True Negative |
| | | (FN) | (TN) |

As seen in the above table, True Positive (TP) is a positive classification of a positive class, False Positive (FP) is a positive classification of a negative class, False Negative (FN) is a negative classification of a positive class, and True Negative (TN) is a negative classification of a negative class.

The performance of a classification model can be measured using performance metrics, such as, e.g., precision, recall, and false positive rate (each of which is described below).

Precision: For a classification model, precision is a model performance metric that refers to a ratio of correct positive predictions output by the classification model to the total predicted positives output by the classification model. Precision can be defined as

$$\frac{TP}{TP + FP}$$

Recall: For a classification model, recall is a model performance metric that refers to a ratio of correct positive predictions to the total positive examples. Recall can be defined as

$$\frac{TP}{TP + FN}$$

False Positive Rate (FPR): For a classification model, FPR is a model performance metric that refers to a ratio of false positive predictions to the total predicted negatives. FPR can be defined as

$$\frac{FP}{FP + TN}$$

### SUMMARY

In general, one innovative aspect of the subject matter described in this specification can be embodied in methods including the operations of obtaining a plurality of training data items and a plurality of labels corresponding to the plurality of training data items, wherein each label represents a ground-truth value for a target attribute relating to the corresponding training data item; identifying a proper subset of training data items from among the plurality of training data items; for each training data item in the proper subset of training data items: generating, using a first machine learning model and for the training data item, a predicted value for the target attribute; and generating, using a second machine learning model and for the training data item, a predicted value for the target attribute; computing, using a linear regression model and based on the respective predicted values generated using the first and second machine learning models, a differential value for a model performance metric and a corresponding confidence interval, wherein: the model performance metric measures a performance attribute relating to a predicted value of a machine learning model, the differential value represents a difference in the respective model performance attribute values for the first and second machine learning models, and the confidence interval indicates a probability that the differential value accurately reflects the difference in the respective model performance attribute values; selecting, based on the computed confidence interval, the first machine learning model; and in response to selecting the first machine learning model, obtaining, using the first machine learning model and for a set of actual data items encountered in a production environment, a corresponding set of predicted values for the target attribute.

These and other implementations can each optionally include one or more of the following features. Methods can include identifying a subset of training data items from among the plurality of training data items that includes: randomly sampling the plurality of training data items to obtain the subset of training data items, wherein the subset of training data items include 10% of the plurality of training data items.

Methods can include the ground-truth value for each label in the plurality of labels is specified by a human.

Methods can include generating, a quality score for each training data item representing a quality of the training data item and the corresponding label; and applying the quality scores as weights for the linear regression model.

Methods can include the model performance metric to include at least one of the following: precision, recall, true positive rate, or false positive rate.

Methods can include the target attribute to be a relevance of search results provided in response to a search query and wherein obtaining, using the first machine learning model and for a set of actual data items encountered in a production environment, a corresponding set of predicted values for the target attribute that includes: obtaining, using the first machine learning model and for a first set of search results corresponding to a first query, a relevance score indicating whether the first set of search results is relevant to the first query.

Methods can include selecting, based on the computed confidence interval, the first machine learning model that includes: determining that the computed confidence interval satisfies a confidence threshold; and in response to determining that the computed confidence interval satisfies a confidence threshold, selecting the first machine learning model.

Particular embodiments of the subject matter described in this specification can be implemented so as to realize one or more of the following advantages. For example, the techniques discussed throughout this specification can be used to select a machine learning model from among multiple machine learning models that are each trained to perform a particular task. The performance of each of the models can be measured using training data. However, rather than evaluate the performance of each of the models based on the entire training data, the techniques described herein utilize a relatively small subset of the training data (e.g., 10% of the training data or some other appropriate subset of the training data), thus achieving time efficiencies and significant reduction in computing resources from evaluating the models on a subset of the training data, while still enabling selection of the machine learning model that performs better than the other machine learning models being evaluated.

The techniques described herein also enable training machine learning models using subsets of high quality dataset that can further reduce time delays in training and reduce the computational resources when compared to evaluating the entire training dataset to generate high quality datasets. For example, longer training times is a method of enhancing machine learning model performance. In contrast, the techniques described here use high quality datasets that use less training time compared to standard techniques. The techniques further help the machine learning models to focus on training samples that are scored higher than other samples thereby allowing the machine learning models to learn faster.

Other advantages of the techniques described in this specification include making informed decisions regarding selection of machine learning models. For example, to select a machine learning model from among two machine learning models, rather than individually assessing the performance of each machine learning model, the techniques compare the relative performance of each machine learning model with the other model. The evaluation, comparison, and selection of machine learning models can be further supported by metrics such as confidence interval and p-value generated during the evaluation process that further allows for a more informed selection decision.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment in which an ecommerce webpage is implemented.

FIG. 2 is a flow diagram of an example process of evaluating and selecting a machine learning model.

FIG. 3 is a flow diagram of an example process of selecting an item for presentation to a buyer

FIG. 4 is a block diagram of an example computer system that can be used to perform operations described.

### DETAILED DESCRIPTION

Given a problem statement, multiple machine learning algorithms can be used to model the data where each machine learning algorithm can be configured based on particular design choices. Since multiple machine learning models can be generated for similar applications in a variety of configurations for a given hypothesis space, evaluating the multiple machine learning models to select a particular machine learning model that performs better (e.g., a model that has better generalization accuracy) than the other evaluated models for a particular task or application can be time and resource intensive. This specification discloses methods, systems, apparatus, and computer readable media for evaluating and comparing the performance of multiple trained machine learning models and selecting a trained machine learning model from among the multiple trained machine learning models. The selected machine learning model can then be deployed by a production environment as a solution to the problem statement.

The techniques and methods described in this specification are explained with reference to an example production environment of an ecommerce website that provides a platform for sellers who use the platform as a tool to sell the items and for buyers who use the platform to search for and purchase items sold by the sellers on the platform. However, one skilled in the art will appreciate that the techniques described in this specification are applicable in any number of applications and systems (e.g., search applications, systems for recommending content or items for provision to users, etc.) where multiple machine learning models may be deployed and evaluated before a particular model is selected for a particular task. In other words, the techniques and methods described herein can be implemented to evaluate performance of machine learning models irrespective of the type of underlying machine learning algorithm. For brevity and ease of explanation, the following descriptions apply the model evaluation techniques described in this specification with reference to the example implementation with respect to an example ecommerce website/platform described below.

On the ecommerce platform, buyers can search the ecommerce website for a particular item by submitting a search query as input to a search system provided by the ecommerce website. The search system can process the query and generate search results that include a list of items responsive to the search query and available for purchase on the ecommerce website. To process the search query, the search system can search through, e.g., item descriptions provided by the sellers or one or more labels or predefined classes corresponding to items provided by the sellers. In some instances, due to incomplete or partial item description and/or due to lack of predefined classes of items, the search system may generate search results that include items with features that are not responsive to or otherwise related to the search query (e.g., returning a table when searching for a chair). Because a buyer is unlikely to buy items that are unrelated to the item that the buyer was searching for, presentation of such items in response to the search query not only wastes computing resources (i.e., resources utilized in identifying and providing these items) but it also negatively affects user experience and user engagement on the ecommerce website.

To address this problem, the search system can utilize a machine learning model to classify the items in the list of items (i.e., items identified by the search system as responsive to the search query) as being “relevant” or “irrelevant” with respect to the search query. For example, the machine learning model can process information relating to features/attributes of an item (e.g., item description, item classification, item reviews, etc.) in the list of items along with the search query, and classify each item in the list of items as being “relevant” or “irrelevant.”

Such a classification model can be selected after evaluation of multiple machine learning models that are trained to perform the same task and subsequent selection of the model that performs better relative to the other evaluated models.

To evaluate the multiple machine learning models, the techniques described in this specification generate, using the models under evaluations, predictions based on a subset of samples from a training dataset. Based on the predictions, the techniques described herein compute the performance of the multiple machine learning models using performance metrics such as, e.g., precision, recall, and FPR. A linear regression model is then generated to model the difference in the performance of the individual machine learning models. Using the linear regression model, confidence and p-value scores are computed to assess the difference in the performance of the evaluated models. Based on the confidence and probability value (referred to as p-value) scores of the difference in performance of the machine learning models, the techniques select a machine learning model from among the multiple machine learning models. In the context of the above-described search system and ecommerce platform, a particular machine learning model can be selected from among other machine learning models that are trained to determine whether an item on the ecommerce platform (that is identified by the search system as responsive to the search query) is relevant or not to the search query.

As described above, the selected machine learning model can be used to classify items identified as responsive to the search query, as relevant or not. After identifying items that are irrelevant, i.e., items that were classified as “not relevant” or “irrelevant,” the identified items can, e.g., either be removed from the list of items before presenting the list to the buyer or lowered in rank so that they are presented lower in the list than other items that were classified as “relevant.”

As another example, the techniques and methods described in this document can also be used in a situation where a buyer can select an item listed on a web page provided by the ecommerce platform (e.g., a search results web page or an item description web page). Upon selection of this item, the ecommerce platform can be configured to present to the buyer other items that are similar to the selected item. To do this, the ecommerce platform is configured to generate a list of other items that are similar to the selected item and present this list to the buyer. In such implementations, the techniques described herein can select a machine learning model from among multiple trained machine learning models that can process features of the selected item (e.g., textual description, images, and item classification) and other items that are determined to be similar to the selected item, to classify each such other items as “related” or “not related” to the selected item. If any item is classified as “related” to the selected item, the item is presented to the buyer. If the item is classified as “not related”, the item is not presented to the buyer.

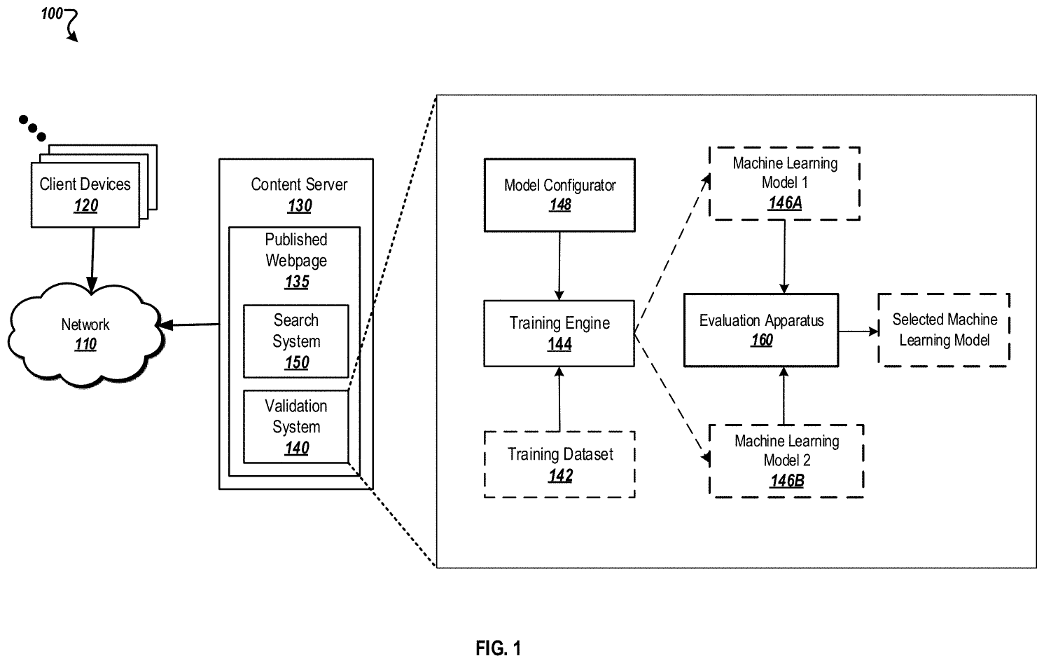

FIG. 1 is a block diagram of an example environment 100 in which the ecommerce website is implemented. The example environment 100 includes a network 110. The network 110 can include a local area network (LAN), a wide area network (WAN), the Internet or a combination thereof. The network 110 can also comprise any type of wired and/or wireless network, satellite networks, cable networks, Wi-Fi networks, mobile communications networks (e.g., 3G, 4G, and so forth) or any combination thereof. The network 104 can utilize communications protocols, including packet-based and/or datagram-based protocols such as internet protocol (IP), transmission control protocol (TCP), user datagram protocol (UDP), or other types of protocols. The network 104 can further include a number of devices that facilitate network communications and/or form a hardware basis for the networks, such as switches, routers, gateways, access points, firewalls, base stations, repeaters or a combination thereof. The network 110 connects client devices 120 and publisher 130. The example environment 100 may include many different content servers 130 and client devices 120.

A client device 120 is an electronic device that is capable of requesting and receiving resources over the network 110. Example client devices 120 include personal computers, mobile communication devices, and other devices that can send and receive data over the network 120. A client device 120 typically includes a user application, such as a web browser, to facilitate the sending and receiving of data over the network 110, but native applications executed by the client device 120 can also facilitate the sending and receiving of data over the network 110.

An electronic document is data that presents a set of content at a client device 120. Examples of electronic documents include webpages, word processing documents, portable document format (PDF) documents, images, videos, search results pages, video games, virtual (or augmented) reality environments, and feed sources. Native applications (e.g., “apps”), such as applications installed on mobile, tablet, or desktop computing devices are also examples of electronic documents. Electronic documents can be provided to client devices 120 by content servers 130. For example, the content servers 130 can include servers that host publisher websites. In this example, the client device 120 can initiate a request for the ecommerce webpage 135, and the content server 130 that hosts the ecommerce web page can respond to the request by sending machine executable instructions that initiate presentation of the webpage 135 at the client device 120.

To facilitate searching of items listed on the ecommerce webpage 135, the environment 100 can include a search system 150 that identifies the items by indexing all items provided by the sellers. Client devices 110 can submit search queries describing items to the search system 150 over the network 110. In response, the search system 150 accesses the search index of identifying items that are relevant to the search query. The search system 150 identifies the items in the form of search results and returns the search results to the client device 120 in a search results page. A search result is data generated by the search system 150 that identifies an items that is responsive (e.g., relevant) to a particular search query, and includes an active link (e.g., hypertext link) that causes a client device to request data from a specified location in response to user interaction with the search result. An example search result can include information related to an item in the form of a web page title, a text describing the item or a portion of an image showing the item extracted from the web page, and the URL of the web page.

Occasionally, search system 150 can select items for inclusion among the search results that are not related to the search query. That is, the item selected by the search system 150 is something that the buyer is not looking for. For example, assume that a seller is selling an item such as a “sports shoe.” While uploading details (for e.g., images and textual description) of the item “shoe” on the ecommerce website, the seller by mistake refers to the shoe as a “slipper.” When a buyer is interested in purchasing a “slipper”, the buyer can use the search system 150 to search for all slippers listed on the ecommerce website. The search system 150 after processing the text description of the “shoe” can conclude that it is a slipper and provide it as a search result to the buyer. To prevent such a false selection, the search system 150 can implement a validation system 140 that implements a machine learning model that classifies each search result as relevant or irrelevant before being presented to the client device 120. For example, the machine learning model implemented by the validation system 140 can process textual description of the item and the search query to generate an indication of the item being “relevant” or “irrelevant” in accordance with the search query.

In some implementations, the validation system 140 is an automated system that is configured to generate, evaluate, and select a trained machine learning model. The machine learning model is configured to receive an input and to process the input in accordance with current values of a set of machine learning model parameters to generate an output based on the input. In general, the machine learning model can be configured to receive any kind of data input, including but not limited to image, video, sound, and text data, and to generate any kind of score, prediction, classification, or regression output based on the input. The output data may be of the same type or modality as the input data, or different.

The validation system 140 can include a training engine 144 that can include one or more processors and is configured to execute a training process to train a machine learning model based on a loss function of the machine learning model and a training dataset 142. In some implementations, the training engine 144 trains the machine learning model by adjusting the values of the machine learning model parameters from current values in order to decrease a loss value generated by the loss function. In this example, the training dataset 142 includes multiple training samples where each sample includes a search query, a textual description of an item and a label indicating whether the item is relevant to the search query. For example, training samples can be as follows

Sample 1

Search Query: Shoe

Text description of an Item: Men's Fashion Sneaker

Label: 1

Sample 2

Search Query: Shoe

Text description of an Item: Men's comfort slides

Label: 0

where “1” indicates that the item is relevant in accordance with the search query and the output “0” indicates that the item is not relevant or irrelevant.

In some implementations, the machine learning model is trained using a training data set and as part of the training, the machine learning model is configured to receive, as input, training samples from a training dataset and generate, as output, a predictive value based on the parameters of the machine learning models.

The validation system 140 can also include a model configurator 148 that can generate and configure various machine learning models based on the machine learning model properties such as the type of machine learning model, the number of parameters of the machine learning model, the optimization techniques etc. For example, if the machine learning model is a neural network, the model configurator 148 can set the number of neural network layers, the number of neurons per layer, activation function, the number of training iterations of the training process, etc.

In the above example, the machine learning models are configured to receive as input the textual description of an item selected by the search system 150 for presentation to the buyer and the search query provided by the buyer to the search system 150. The machine learning models are further configured to process the two inputs and generate as output an indication such as “1” and “0” where the output “1” indicates that the item is relevant to the search query and the output “0” indicates that the item is not relevant or irrelevant to the search query.

In some implementations, the validation system 140 can generate two or more trained machine learning models for the same task where each of the multiple trained machine learning models has a different configuration. For example, the validation system 140 can train a first machine learning model 146A and a second machine learning model 146B. The first machine learning model 146A and the second machine learning model 146B have different configurations. For example, the first machine learning model 146A can be a neural network model and the second machine learning model can be a logistic regression model. In another example, the first machine learning model 146A can be a neural network model with n layers and the second machine learning model can also be a neural network with m layers.

In some implementations, the validation system 140 can select a machine learning model from among the multiple machine learning models. To do this the validation system 140 can implement an evaluation apparatus 160 that can compare the multiple machine learning models based on one or more model performance metrics such as precision, recall and false positive rate (FPR). For example, the evaluation apparatus 160 can evaluate the first machine learning model 146A and the second machine learning model 146B to select a machine learning model that can be used by the validation system 140 to check the relevance of the search items with respect to the search query. In another example, when there are more than two machine learning models, the evaluation apparatus 160 can select a machine learning model by comparing pairs of machine learning models sequentially. For example, if there are three machine learning models, the evaluation apparatus 160 can evaluate the first and the second machine learning models to select a machine learning model and then evaluate the selected model and the third model to select a final machine learning model.

In some implementations, to evaluate the multiple machine learning models, the evaluation apparatus 160 can select a proper subset of the training dataset 142. The proper subset of the training dataset can be selected, for example, using random sampling, stratified sampling, etc., of the training dataset. In some implementations, after selecting the proper subset of the training dataset, the subset can be evaluated to ensure that the subset is representative of the training dataset. Representativeness can be assessed in various ways such as, e.g., the ratio of labels or other attributes in the training dataset. In some implementations, a proper subset of training samples is representative of the training dataset 142 when the proportional distribution of samples across labels in the proper subset is the same as the proportion distribution of samples across labels in the entire training dataset 142. For example, if the training dataset 142 has 10,000 samples such that 5000 training samples have a label “1” and the remaining 5000 training samples have a label “0”, then the ratio of labels is 1:1. To maintain the representativeness of the training dataset 142, the subset of the training dataset will maintain the same ratio of labels. For example, if the subset of training dataset 142 includes 1000 training samples, then at least 500 training samples will have label “0” and at least 500 training samples will have label “1”. Depending on the particular implementation, the size of the subset of the training dataset can be pre-defined. For example, the size of the subset of the training dataset can be 10% of the size of the training dataset 142.

In some implementations, the subset of the training dataset can undergo a quality check, which can involve, e.g., human evaluation, to identify and correct any inconsistencies (e.g., incorrect labels) with the training samples in the subset of the training dataset. For example, after selecting the subset of the training dataset, the training samples of the subset can be provided to human annotators to verify whether the labels of the training samples are correct. In the current example, the human annotators can evaluate the label of a particular training sample based on the search query and the item description. If for a particular sample, the human annotators conclude that the label of the particular sample is wrong, the human annotators can change the label to the correct label. For example, if the search query and the textual description of an item for a particular sample are “shoes” and “Men's Fashion Sneaker” respectively and the corresponding label for the particular sample is “1” indicating that an item described as “Men's Fashion Sneaker” is a valid search result when the buyer is looking an item using the search query “shoes”, the human annotator can conclude that the sample is correct and requires no change. If the label is “0” indicating that sample is wrongly labelled, the human annotator can conclude that the sample is incorrect and can change the label from “0” to “1”. The human annotated labels can be represented as {yᵢ}ⁿ where y is the label for each sample indexed using i=0 to n. Another example of quality check can include evaluation of the training samples using a machine learning model (referred to as an expert machine learning model) that has already been trained to process the training samples and generate labels as predictions. In such a situation, the expert machine learning model can process the training samples and generate a prediction (referred to as an expert prediction). The expert predictions can be compared to the already defined labels on the training samples to conclude whether the already defined labels of the training samples in the subset of the training dataset are the correct labels.

In some implementations, the human annotated labels can be assigned a score by the human annotators according to the correctness of a label with respect to the input features of a respective training sample. In some implementations, the score assigned can be a value between 0 and 1. However, depending on the implementations, the score can take values including values greater than 1. For example, if there is a high confidence in the correctness of a label (and assuming a label score that can range between 0 and 1), the label can be assigned a higher score. Similarly, if there is a low confidence in the correctness of a label, the label can be assigned a lower score. In this example, the score can be assigned by the human annotators. For example, if a human annotator, while evaluating a training sample, has a higher confidence that the item described by the textual description is relevant to the search query of the training sample, the human annotator can assign a high score to the training sample. The human annotated labels and the respective scores can be represented as {yᵢ, wᵢ}ⁿ where y is the label and w is the score for each sample, indexed using i=0 to n. In implementations, where the training samples are evaluated by an entity other than the human annotators, e.g., the expert machine learning model, the scores are assigned by that other entity.

In some implementations, after selecting and verifying the authenticity of the subset of training dataset, the evaluation apparatus 160 can use the multiple machine learning models to process the training samples of the subset of training dataset to generate corresponding predictive values. For example, the evaluation apparatus 160 can use the first machine learning model 146A to generate predicted labels for each sample in the proper subset of the training dataset. Similarly, the evaluation apparatus 160 can use the second machine learning model 146B to generate predicted labels for each sample in the subset of the training dataset. For brevity, the predicted labels of each of the first and the second machine learning models are referred to as first and second predicted labels, respectively. The first and the second predicted labels can be represented as {ŷᵢ₀, ŷᵢ₁}ᵢ₌₁ⁿ where ŷᵢ₀ is the predicted label of the i-th sample generated using the first machine learning model and ŷᵢ₁ is the predicted label of the i-th sample generated using the second machine learning model.

In some implementations, to evaluate the multiple machine learning models, the evaluation system 160 can model the difference of the respective predicted labels as a weighted linear regression. For example, the evaluation apparatus 160 can model the difference of the predicted labels generated by the first machine learning model 146A and the second machine learning model 146B as a weighted linear regression using the scores assigned to the labels of the subset of the training dataset as the weights for the weighted linear regression. The weighted linear regression can be represented as follows:

ŷᵢ₁−ŷᵢ₀= [symbol] {yᵢ=0}+\hat{β}1{yᵢ=1}+ϵᵢ for i=1,2 . . . n and (ϵ₁, . . . ϵₙ)˜N(0,Σ) and W=diag(w₁, . . . wₙ) (eq. 1)

where N is a zero-centered Gaussian distribution and (\hat{α}, \hat{β}) are least-square estimates of the α and β, which are the difference between FPR and recall, respectively, of the first and the second machine learning models. As described above, FPR and recall are model performance metrics that indicate the performance of each model. In this example, FPR can be defined as P(yᵢ=0) and recall can be defined as P(yᵢ=1). Using these definitions of FPR and recall, α and β can be defined as

α=P(yᵢ=0)−P(yᵢ=0) (eq. 2)

β=P(yᵢ=1)−P(yᵢ=1) (eq. 3)

where E[(\hat{α}, \hat{β})]=(α, β) is the expectation of the least-square estimates of the α and β.

In some implementations, an alternative approach can be implemented to estimate the values of α and β. In such implementations, the evaluation apparatus 160 can execute two regressions to estimate the values of α and β. The two regressions are as follows

ŷᵢ₁−ŷᵢ₀=α+ϵᵢ for i where yᵢ=0 (eq. 4)

ŷᵢ₁−ŷᵢ₀=β+ϵᵢ for i where yᵢ=1 (eq. 5)

where α indicates the expected disagreement between the first and the second machine learning models when yᵢ=0, β indicates the expected disagreement between the first and the second machine learning models when yᵢ=1, ϵᵢ indicates additional variability of differences in model prediction of the first and the second machine learning models due to noise that is modelled as a zero-centered Gaussian distribution and ŷᵢ₁−ŷᵢ₀ indicates the observed disagreement between the first machine learning model and the second machine learning model when being considered for a training sample i. For example, if ŷᵢ₁−ŷᵢ₀=0, it would indicate that the first and the second machine learning models generate the same prediction for a training sample i. Similarly, if ŷᵢ₁−ŷᵢ₀< >0, it would indicate that the first and the second machine learning models do not generate the same prediction for the training sample i.

In some implementations, after estimating the values of α and β, that is, after computing the values \hat{α} and \hat{β}, the evaluation system 150 can further compute the confidence intervals (CI) and p-value for \hat{α} and \hat{β}. For example, a 95% CI for \hat{α} shows 95% confidence in the estimated FPR difference between the first and the second machine models. For example, if the estimated FPR difference between the first and the second machine model is positive, the evaluation apparatus 160 can determine that the first machine learning model has a lower FPR than the second machine learning model. In another example, a 95% CI for \hat{β} shows 95% in the estimated recall difference between the first and the second machine model. If the estimated recall difference is low, the evaluation apparatus 160 can determine that the first machine learning model has a lower recall than the second machine learning model.

In some implementations, the evaluation apparatus 160 can use other model performance metrics, such as precision, to model the difference of the predicted labels generated by the first machine learning model 146A and the second machine learning model 146B. In this example, precision for the first machine learning model can be defined as a conditional probability Pᵢ₀=P(yᵢ=1|ŷᵢ₁=1) and the precision for the second machine learning model can be defined as a conditional probability Pᵢ₁=P(yᵢ=1|ŷᵢ₁=1). To compare the performance of the first machine learning model 146A with the second machine learning model 146B, the evaluation apparatus 160 can compute the difference of the precision values of the first machine learning model and the second machine learning model as follows:

P₁−P₀=P(yᵢ=1|ŷᵢ₁=1)−P(yᵢ=1|ŷᵢ₀=1) (eq. 6)

where P₁−P₀ is the difference in the precision between the first machine learning model and the second machine learning model.

In some implementations, when comparing the performance of the machine learning models using precision, the evaluation apparatus 160 can model the predicted first labels ŷᵢ₀ and the predicted second labels ŷᵢ₁ to determine the marginal predictive ability while accounting for correlations between the first and the second machine learning models. This can be represented as follows

ŷᵢ₀=γ₀1(ŷᵢ₁=0)+β₀1(ŷᵢ₁=1)+η_{i′} where η_{i′}˜N(0,σ_{η}²) (eq. 7)

ŷᵢ₁=γ₁1(ŷᵢ₀=0)+β₁1(ŷᵢ₀=1)+v_{i′} where v_{i′}˜N(0,σᵥ²) (eq. 8)

yᵢ=α₀₁1(ŷᵢ₀=0,ŷᵢ₁=1)+α₁₀1(ŷᵢ₀=1,ŷᵢ₀=0)+α₁₁1(ŷᵢ₀=1,ŷᵢ₁=1)+ϵ_{i′} (eq. 9)

where (ϵ₁, ϵ₂ . . . ϵₙ)˜N(0, Σ) and W=(w₁, w₂ . . . wₙ). Here eq. 7 captures the ability of the second machine learning model 146A to predict the label “0”. Similarly, eq. 8 captures the ability of the first machine learning model 146A to predict the label “1”. Finally, eq. 9 captures the joint ability of first and the second machine learning models to predict the observed outcomes of the training sample i.

In some implementations, the evaluation apparatus 160 can obtain the estimates \hat{θ} of the first and the second machine learning model as \hat{θ}=( [symbol] , [symbol] , [symbol] , [symbol] , [symbol] ). The evaluation apparatus 160 also estimates the covariance structure \hat{Π} that accounts for the covariance caused due to sampling the subset of the training dataset and reusing the samples of the subset for evaluation.

\hat{Π}=blockdiag[cov( [symbol] ),cov( [symbol] ),cov( [symbol] , [symbol] , [symbol] )] (eq. 10)

In some implementations, the difference of the precision values of the first machine learning model and the second machine learning model can be estimated using non-linear transformation T of parameters in θ. This can be represented as follows:

P₁−P₀=τ=[α₁₁*β₀+α₀₁*(1−β₀)]−[α₁₁*β₁+α₁₀*(1−β₁)] (eq. 11)

In some implementations, the evaluation apparatus 160 can use delta methods to compute:

∇_{θ}τ=(α₁₁−α₀₁,α₁₀−α₁₁,1−β₀,1−β₁,β₀−β₁)=M*(1,β₀,β₁,α₀₁,α₁₀,α₁₁)^{T} (eq. 12)

where ∇_{θ}τ is the partial derivative of r that is used to capture the relative curvature of the non-linear transformation τ and

$$M = ( \begin{matrix}0 & 0 & 0 & - 1 & 0 & 1 \\ 0 & 0 & 0 & 0 & 0 & - 1 \\ 1 & - 1 & 0 & 0 & 0 & 0 \\ 1 & 0 & - 1 & 0 & 0 & 0 \\ 0 & 1 & - 1 & 0 & 0 & 0\end{matrix} )$$

where M is the matrix transformation that captures the curvature of the non-linear transformation τ.

In some implementations, the evaluation apparatus 160 can estimate the variance of the difference of the precision values of the first machine learning model and the second machine learning model using:

\hat{V}=(∇_{\hat{θ}}(\hat{τ}))^{T}·Π·∇_{\hat{θ}}(\hat{τ}) (eq. 13)

where \hat{V} is the estimated variance of the difference of the precision values of the first machine learning model and the second machine learning model, and \hat{τ} is the estimated value of non-linear transformation τ. In some implementations, the evaluation apparatus 160 can compute the CI of the estimated difference of the precision values of the first machine learning model and the second machine learning model using

$$\hat{τ} \pm {z}_{1 - ( \frac{α}{2} )} \sqrt{\hat{V}} .$$

In some implementations, the evaluation apparatus 160 can compute p-values for the significance of the estimated difference of the precision values of the first machine learning model and the second machine learning model using

$$p - value = 2 ϕ ( \frac{τ}{\sqrt{\hat{V}}} )$$

where ϕ(z) is the standard normal cumulative distribution function.

In some implementations, after determining the performance of the multiple machine learning models based on the difference in one or more model performance metrics, such as precision, recall and FPR, using CI and p-value, the evaluation apparatus 160 can select based on a pre-specified threshold, a machine learning models from multiple machine learning models generated by the validation system. For example, if the evaluation apparatus 160 determines that the p-value corresponding to the difference in FPR is less than or equal to a pre-specified threshold of 0.05, the machine learning models 146A and 126B are said to have significantly different performances. In some implementations, the apparatus 160 can compute the sign of the estimated difference of the precision values of the first machine learning model and the second machine learning model to determine the directionality of the result using sign(\hat{τ}). For example if the p-value is significant (below a pre-specified threshold of 0.05) and sign(\hat{τ})>0, the evaluation apparatus 160 can select the first machine learning model 146A for deployment. Alternatively if sign(\hat{τ})<0, the evaluation apparatus 160 can select the second machine learning model 146B for deployment

In some implementations, after selecting a particular machine learning model by the evaluation apparatus 160, the validation system 140 can deploy the selected machine learning model for the specific task for which the particular machine learning model (as well as other multiple machine learning models that were evaluated by the evaluation apparatus 160) was trained. For example, the validation system 140 deploys the first machine learning model 146A to classify each item in the list of items selected by the search system 150 in response to the buyer submitting a search query as being “relevant” or “irrelevant”. For example, after deployment, the first machine learning model 146A can process a search query provided by a buyer and one or features of an item (e.g., a textual description of an item) selected by the search system 150 as responsive to the search query, to classify the selected item as being relevant or irrelevant to the search query. If the item is classified as “relevant,” the item is presented to the buyer on the client device 120 and if the item is classified as “irrelevant,” the item is filtered out and not presented to the buyer.

In some implementations, the techniques and methods described in this specification can be used to train a machine learning model so as to increase the performance of a machine learning model. For example, assume that a first machine learning model is a light-weight and a less complex machine learning model (for e.g., the first machine learning model has fewer number of training parameters) that needs to be trained, and a second machine learning model is a complex machine learning model that has been trained to learn complex relationships pertaining to a particular problem (such as the search result relevance classification described above). The techniques described in this specification can be used to compare the performance of the first and the second machine learning model. Based on the difference in the model performance metrics, the first machine learning model is further trained so as to minimize the difference in the model performance metrics, thereby enabling the first machine learning model to learn the complex relationships pertaining to the particular problem.

The techniques and methods also allow for an iterative method of sampling a subset of training dataset, evaluating the subset using human annotators, and training machine learning models. For example, instead of annotating and validating the entire training dataset which is generally time consuming and expensive (e.g., from a computing resource standpoint), a subset of the training dataset is sampled that can be used to train machine learning models. The process can be repeated until the performance of the machine learning model meets a certain threshold thereby removing the need of annotating and evaluating the entire dataset.

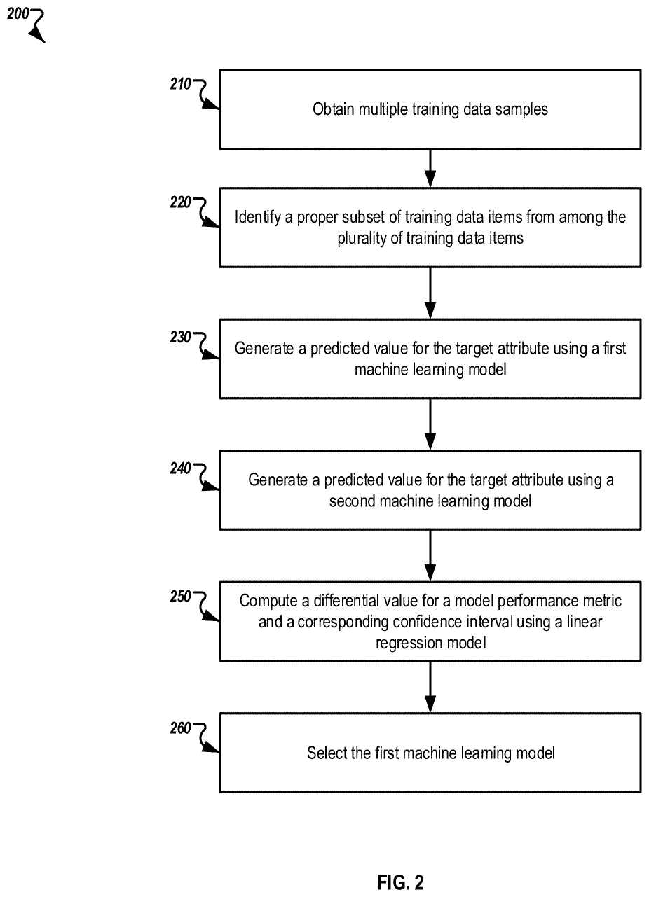

FIG. 2 is a flow diagram of an example process 200 of evaluating and selecting a machine learning model. Operations of the process 200 can be implemented for example by the validation system 140, which implements the machine learning model to classify the items in the search result generated by the search system 150. To implement the model, the validation system 140 includes a training engine 144 and a model configurator that can generate multiple machine learning models. Once multiple machine learning models are generated and/or trained, the evaluation apparatus 160 within the validation system 140 evaluates the multiple machine learning models and based on the evaluation selects one of the machine learning models from among the multiple machine learning models. Operations of the process 200 can also be implemented as instructions stored on one or more computer readable media which may be non-transitory, and execution of the instructions by one or more data processing apparatus can cause the one or more data processing apparatus to perform the operations of the process 200.

The evaluation apparatus 160 obtains multiple training data samples (210). For example, the validation system 140 obtains a training dataset to train multiple machine learning models to generate a predictive value depending on the problem being solved using the machine learning model. In the example of the ecommerce webpage 135, the validation system 140 obtains a training dataset 142 that includes multiple training samples where each sample includes a search query, a textual description of an item and a label indicating whether the item is relevant to the search query. For example, training samples can be as follows

Sample 1

Search Query: Shoe

Text description of an Item: Men's Fashion Sneaker

Label: 1

Sample 2

Search Query: Shoe

Text description of an Item: Men's comfort slides

Label: 0

where “1” indicates that the item is relevant in accordance with the search query and the output “0” indicates that the item is not relevant or irrelevant.

The evaluation apparatus 140 identifies a proper subset of training data samples (220). For example, the evaluation apparatus 160 can select a proper subset of the training dataset 142. The subset of the training dataset can be selected for example using techniques such as random sampling to select training data samples from the training dataset 142. Depending on the particular implementation, the size of the subset of the training dataset can be pre-defined. For example, the size of the subset of the training dataset can be 10% of the size of the training dataset 142.

The subset of the training dataset can undergo a quality check, which can involve, e.g., human evaluation, to identify and correct any inconsistencies (e.g., incorrect labels) with the training samples in the subset of the training dataset. For example, after selecting the subset of the training dataset, the training samples of the subset can be provided to human annotators to verify whether the labels of the training samples are correct. In the current example, the human annotators can evaluate the label of a particular training sample based on the search query and the item description. If for a particular sample, the human annotators conclude that the label of the particular sample is wrong, the human annotators can change the label to the correct label. For example, if the search query and the textual description of an item for a particular sample are “shoes” and “Men's Fashion Sneaker” respectively and the corresponding label for the particular sample is “1” indicating that an item described as “Men's Fashion Sneaker” is a valid search result when the buyer is looking an item using the search query “shoes”, the human annotator can conclude that the sample is correct and requires no change. If the label is “0” indicating that sample is wrongly labelled, the human annotator can conclude that the sample is incorrect and can change the label from “0” to “1”. The human annotated labels can be represented as {yᵢ}ⁿ where y is the label for each sample indexed using i=0 to n. Another example of quality check can include evaluation of the training samples using a machine learning model (referred to as an expert machine learning model) that has already been trained to process the training samples and generate labels as predictions. In such a situation, the expert machine learning model can process the training samples and generate a prediction (referred to as an expert prediction). In the example described above, the expert prediction can be labels “0” and “1” generated by the expert machine learning model by processing the training samples in the subset of the training dataset. The expert predictions can be compared to the already defined labels on the training samples to conclude whether the already defined labels of the training samples in the subset of the training dataset are the correct labels.

The human annotated labels can be assigned a score by the human annotators according to the correctness of a label with respect to the input features of a respective training sample. For example, if there is a high confidence in the correctness of a label, the label can be assigned a higher score. Similarly, if there is a low confidence in the correctness of a label, the label can be assigned a lower score. In this example, the score can be assigned by the human annotators. For example, if a human annotator, while evaluating a training sample, has a higher confidence that the item described by the textual description is relevant to the search query of the training sample, the human annotator can assign a high score to the training sample. The human annotated labels and the respective scores can be represented as {yᵢ, wᵢ}ⁿ where y is the label and w is the score for each sample indexed using i=0 to n. In implementations, where the training samples are evaluated by any entity other than the human annotators for e.g., the expert machine learning model, the scores are assigned by the entity.

The evaluation apparatus 160 generates a predicted value for the target attribute using a first machine learning model (230). For example, to evaluate the first machine learning model 146A and the second machine learning model 146B generated by the validation system 140, the evaluation apparatus 160 can use the first machine learning model 146A to generate predicted labels for each data sample in the subset of the training dataset. Similarly, the evaluation apparatus 160 can use the second machine learning model 146B to generate predicted labels for each sample in the subset of the training dataset (240). For brevity, let's name the predicted labels of the first and the second machine learning model as first and second predicted labels respectively. The first and the second predicted labels can be represented as {ŷᵢ₀, ŷᵢ₁}ᵢ₌₁ⁿ where ŷᵢ₀ is the predicted label of the i-th sample generated using the first machine learning model and ŷᵢ₁ is the predicted label of the i-th sample generated using the second machine learning model.

The evaluation apparatus 160 computes a differential value for a model performance metric and a corresponding confidence interval using a linear regression model (250). For example, to evaluate the multiple machine learning models, the evaluation system 160 can model the difference of the respective predicted labels as a weighted linear regression. For example, the evaluation apparatus 160 can model the difference of the predicted labels generated by the first machine learning model 146A and the second machine learning model 146B as a weighted linear regression using the scores assigned to the labels of the subset of the training dataset as the weights for the weighted linear regression. The weighted linear regression can be represented as follows:

ŷᵢ₁−ŷᵢ₀= [symbol] {yᵢ=0}+ [symbol] {yᵢ=1}+ϵᵢ for i=1,2 . . . n and (ϵ₁, . . . ϵₙ)˜N(0,Σ) and W=diag(w₁, . . . wₙ) (eq. 1)

where N is a zero-centered Gaussian distribution and (\hat{α}, \hat{β}) are least-square estimates of the α and β, which are the difference between FPR and recall, respectively, of the first and the second machine learning models. Note that the FPR and recall are model performance metrics that indicate the performance of each model. In this example, FPR can be defined as P(yᵢ=0) and recall can be defined as P(yᵢ=1). Using these definitions of FPR and recall, α and β can be defined as

α=P(yᵢ=0)−P(yᵢ=0) (eq. 2)

β=P(yᵢ=1)−P(yᵢ=1) (eq. 3)

where E[(\hat{α}, \hat{β})]=(α, β) is the expectation of the least-square estimates of the α and β.

The evaluation apparatus 160 can implement an alternative approach to estimate the values of α and β. In such implementations, the evaluation apparatus 160 can execute two regression models to estimate the values of α and β. The two regression models are as follows

ŷᵢ₁−ŷᵢ₀=α+ϵᵢ for i where yᵢ=0 (eq. 4)

ŷᵢ₁−ŷᵢ₀=β+ϵᵢ for i where yᵢ=1 (eq. 5)

The evaluation apparatus 160 can also use precision to compare the performances of the first machine learning model 146A and the second machine learning model 146B. The evaluation apparatus 160 can estimate the variance of the difference of the precision values of the first machine learning model and the second machine learning model using

\hat{V}(∇_{\hat{θ}}(\hat{τ}))^{T}·Π·∇_{\hat{θ}}(\hat{τ}) (eq. 13)

and where \hat{V} is the estimated variance of the difference of the precision values of the first machine learning model and the second machine learning model and \hat{τ} is the estimated difference of the precision values of the first machine learning model and the second machine learning model. In some implementations, the evaluation apparatus 160 can compute the CI of the estimated difference of the precision values of the first machine learning model 146A and the second machine learning model 146B using

$$\hat{τ} \pm {z}_{1 - ( \frac{α}{2} )} \sqrt{\hat{V}} .$$

After computing the values \hat{α} and \hat{β}, the evaluation system 150 can further compute the confidence intervals (CI) and p-value for \hat{α} and \hat{β}.

The evaluation apparatus 160 selects the first machine learning model (260). For example, based on a 95% CI for \hat{α} that indicates a 95% confidence in the estimated FPR difference between the first and the second machine model and if the estimated FPR difference between the first and the second machine model is positive, the evaluation apparatus 160 can determine that the first machine learning model has a lower FPR than the second machine learning model. In another example, a 95% CI for \hat{β} shows 95% in the estimated recall difference between the first and the second machine model. If the estimated recall difference is negative, the evaluation apparatus 160 can determine that the first machine learning model has a lower recall than the second machine learning model.

After determining the performance of the multiple machine learning models based on the difference in the model performance metrics such as precision, recall and FPR, the evaluation apparatus 160 can select based on a pre-specified threshold, one or more machine learning models from multiple machine learning models generated by the validation system. For example, if the evaluation apparatus 160 determines that the confidence of the first machine learning model 146A having a lower FPR than the second machine learning model is equal to or more than a pre-specified threshold of 95%, the evaluation apparatus 160 can select the first machine learning model for deployment.

After selecting a machine learning model by the evaluation apparatus 160, the validation system 140 can deploy the selected machine learning model for the specific problem for which the multiple machine learning models were trained.

Although FIG. 2 has been explained with reference to binary classification models, the techniques and methods described with reference to FIG. 2 can be used to evaluate and compare multi-class machine learning models. For example, assume that the machine learning models to be evaluated are multi-class machine learning models that can classify between three classes (for e.g., classes A, B and C), then the multi-class machine learning models can be treated as binary classification models. For example, the multi-class machine learning models can be treated as a binary classification model that can classify between class A and classes B or C. Similarly, the multi-class machine learning models can be treated as a binary classification model that can classify between class B Vs classes A or C and class C Vs classes A or B. For each of the classifications, model performance metrics can be computed. For example, each machine learning model can generate a precision, recall or FPR for each of the multiple classes that can further be used to evaluate, compare and select a machine learning model.

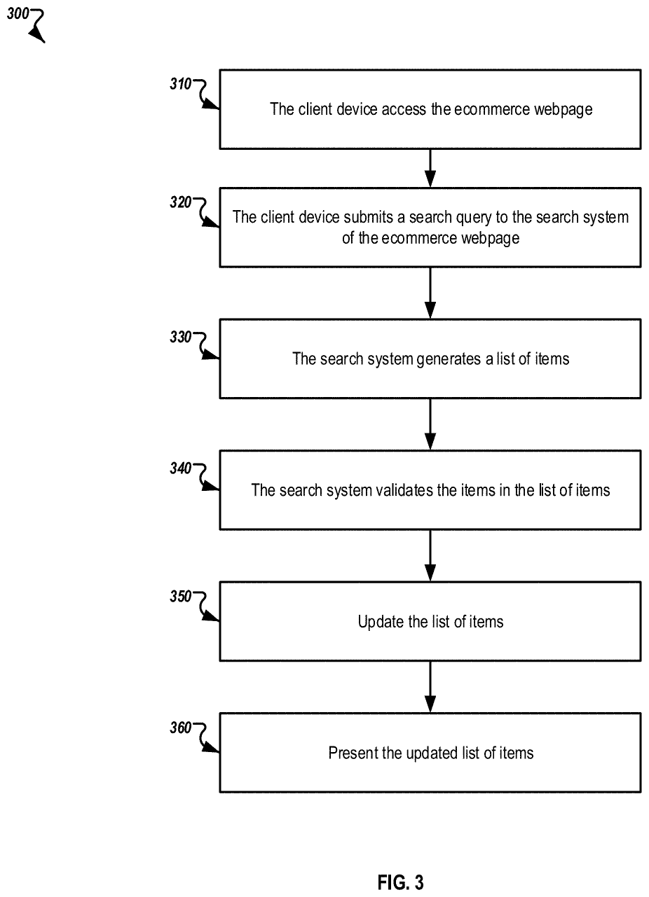

FIG. 3 is a flow diagram of an example process 300 of selecting an item for presentation to a buyer. Operations of the process 300 can be implemented for example by the client device 120, content server 130, search system 150 and validation system 140. Operations of the process 300 can also be implemented as instructions stored on one or more computer readable media which may be non-transitory, and execution of the instructions by one or more data processing apparatus can cause the one or more data processing apparatus to perform the operations of the process 300.

The client device 120 accesses the ecommerce webpage 135 (310). For example, the buyer can use the client device 120 to initiate a request for the ecommerce webpage 135, and the content server 130 that hosts the ecommerce webpage 135 can respond to the request by sending machine executable instructions that initiate presentation of the webpage 135 at the client device 120.

The client device 120 submits a search query to the search system of the ecommerce webpage 135 (320). For example, the buyers can search the ecommerce website for a particular item by providing a search query as input to a search system 150 provided by the ecommerce website 135.

The search system 150 can process the query and generate a list of relevant items available for purchase on the ecommerce website (330). To process the search query, the search system 150 can search through item descriptions provided by the sellers or select items based on one or more labels or predefined classes provided by the sellers. The search system 150 can determine a similarity between the search query and item descriptions listed on the ecommerce platform to identify items that have a textual description similar to the search query.

The search system 150 validates the items in the list of items (340). Occasionally search system 150 can select items that are not related to the search query. That is, the item selected by the search system 150 is not relevant to the search query. To prevent this, the search system 150 can implement a validation system 140 that implements a machine learning model that classifies each search result as relevant or irrelevant before being presented to the client device 120. For example, the machine learning model implemented by the validation system 140 can process textual description of the item and the search query to generate an indication of the item being “relevant” or “irrelevant” in accordance with the search query.

As explained with reference to FIG. 2, the validation system 140 is an automated system that is configured to generate, evaluate and select a trained machine learning model. To implement the model, the validation system 140 includes a training engine 144 and a model configurator 148 that can generate multiple machine learning models. Once multiple machine learning models are generated, the evaluation apparatus 160 within the validation system 140 evaluates the multiple machine learning models and based on the evaluation selects one of the machine learning models from among the multiple machine learning models. For example, the training engine 144 and the model configurator 148 of the validation system 140 can train a first machine learning model 146A and a second machine learning model 146B such that the two machine learning models using a training dataset 142. The validation system 140 can select a machine learning model from among the two machine learning models. To do this the validation system 140 can implement an evaluation apparatus 160 that can compare the two machine learning models based on one or more model performance metrics such as precision, recall and false positive rate (FPR) using the process 200.

The validation system 140 updates the list of items (350). For example, after selecting the a machine learning model by the evaluation apparatus 160, the validation system 140 can deploy the selected machine learning model to classify each item in the list of items selected by the search system 150 in response to the buyer submitting a search query as being “relevant” or “irrelevant”. For example, after selecting and deploying the first machine learning model 146A, the model 146A can process a search query provided by a buyer and a textual description of an item in the list of items selected by the search system 150 to classify the item as being relevant or irrelevant to the search query. If the item is classified as “relevant”, the item is presented to the buyer on the client device 120 and if the item is classified as “irrelevant”, the item is filtered out to update the list of items. The updated list of items is then transmitted to the client device 120 over the network 110 and presented to the buyer (360).

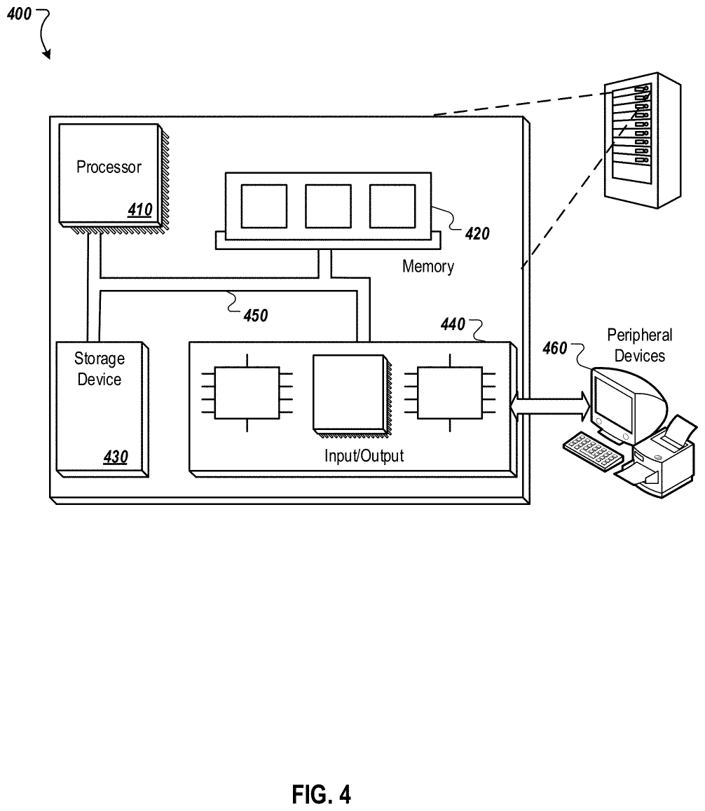

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to peripheral devices 460, e.g., keyboard, printer and display devices. Other implementations, however, can also be used, such as mobile computing devices, mobile communication devices, set-top box television client devices, etc.

Although an example processing system has been described in FIG. 3, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage media (or medium) for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
obtaining a plurality of training data items and a plurality of labels corresponding to the plurality of training data items, wherein each label represents a ground-truth value for a target attribute relating to the corresponding training data item;
identifying a proper subset of training data items from among the plurality of training data items;
for each training data item in the proper subset of training data items:
generating, using a first machine learning model and for the training data item, a predicted value for the target attribute; and
generating, using a second machine learning model and for the training data item, a predicted value for the target attribute;
computing, using a linear regression model and based on the respective predicted values generated using the first and second machine learning models, a differential value for a model performance metric and a corresponding confidence interval, wherein:
the model performance metric measures a performance attribute relating to a predicted value of a machine learning model,
the differential value represents a difference in the respective model performance attribute values for the first and second machine learning models, and
the confidence interval indicates a probability that the differential value accurately reflects the difference in the respective model performance attribute values;
selecting, based on the computed confidence interval, the first machine learning model; and
in response to selecting the first machine learning model, obtaining, using the first machine learning model and for a set of actual data items encountered in a production environment, a corresponding set of predicted values for the target attribute.

2. The computer-implemented method of claim 1, wherein identifying a subset of training data items from among the plurality of training data items, comprises:
randomly sampling the plurality of training data items to obtain the subset of training data items, wherein the subset of training data items include 10% of the plurality of training data items.

3. The computer-implemented method of claim 1, wherein the ground-truth value for each label in the plurality of labels is specified by a human.

4. The computer-implemented method of claim 1, further comprising:
generating, for each training data item, a quality score representing a quality of the training data item and the corresponding label; and
applying the quality scores as weights for the linear regression model.

5. The computer-implemented method of claim 1, wherein the model performance metric includes at least one of the following: precision, recall, true positive rate, or false positive rate.

6. The computer-implemented method of claim 1, wherein the target attribute is a relevance of search results provided in response to a search query and wherein obtaining, using the first machine learning model and for a set of actual data items encountered in a production environment, a corresponding set of predicted values for the target attribute, comprises:
obtaining, using the first machine learning model and for a first set of search results corresponding to a first query, a relevance score indicating whether the first set of search results is relevant to the first query.

7. The computer implemented method of claim 1, wherein selecting, based on the computed confidence interval, the first machine learning model comprises:
determining that the computed confidence interval satisfies a confidence threshold; and
in response to determining that the computed confidence interval satisfies a confidence threshold, selecting the first machine learning model.

8. A system, comprising:
obtaining a plurality of training data items and a plurality of labels corresponding to the plurality of training data items, wherein each label represents a ground-truth value for a target attribute relating to the corresponding training data item;
identifying a proper subset of training data items from among the plurality of training data items;
for each training data item in the proper subset of training data items:
generating, using a first machine learning model and for the training data item, a predicted value for the target attribute; and
generating, using a second machine learning model and for the training data item, a predicted value for the target attribute;
computing, using a linear regression model and based on the respective predicted values generated using the first and second machine learning models, a differential value for a model performance metric and a corresponding confidence interval, wherein:
the model performance metric measures a performance attribute relating to a predicted value of a machine learning model,
the differential value represents a difference in the respective model performance attribute values for the first and second machine learning models, and
the confidence interval indicates a probability that the differential value accurately reflects the difference in the respective model performance attribute values;
selecting, based on the computed confidence interval, the first machine learning model; and
in response to selecting the first machine learning model, obtaining, using the first machine learning model and for a set of actual data items encountered in a production environment, a corresponding set of predicted values for the target attribute.

9. The system of claim 8, wherein identifying a subset of training data items from among the plurality of training data items, comprises:
randomly sampling the plurality of training data items to obtain the subset of training data items, wherein the subset of training data items include 10% of the plurality of training data items.

10. The system of claim 8, wherein the ground-truth value for each label in the plurality of labels is specified by a human.

11. The system of claim 8, further comprising:
generating, for each training data item, a quality score representing a quality of the training data item and the corresponding label; and
applying the quality scores as weights for the linear regression model.

12. The system of claim 8, wherein the model performance metric includes at least one of the following: precision, recall, true positive rate, or false positive rate.

13. The system of claim 8, wherein the target attribute is a relevance of search results provided in response to a search query and wherein obtaining, using the first machine learning model and for a set of actual data items encountered in a production environment, a corresponding set of predicted values for the target attribute, comprises:
obtaining, using the first machine learning model and for a first set of search results corresponding to a first query, a relevance score indicating whether the first set of search results is relevant to the first query.

14. The system of claim 8, wherein selecting, based on the computed confidence interval, the first machine learning model comprises:
determining that the computed confidence interval satisfies a confidence threshold; and
in response to determining that the computed confidence interval satisfies a confidence threshold, selecting the first machine learning model.

15. A non-transitory computer readable medium of storing instructions that, when executed by one or more data processing apparatus, cause the one or more data processing apparatus to perform operations comprising:
obtaining a plurality of training data items and a plurality of labels corresponding to the plurality of training data items, wherein each label represents a ground-truth value for a target attribute relating to the corresponding training data item;
identifying a proper subset of training data items from among the plurality of training data items;
for each training data item in the proper subset of training data items:
generating, using a first machine learning model and for the training data item, a predicted value for the target attribute; and
generating, using a second machine learning model and for the training data item, a predicted value for the target attribute;
computing, using a linear regression model and based on the respective predicted values generated using the first and second machine learning models, a differential value for a model performance metric and a corresponding confidence interval, wherein:
the model performance metric measures a performance attribute relating to a predicted value of a machine learning model,
the differential value represents a difference in the respective model performance attribute values for the first and second machine learning models, and
the confidence interval indicates a probability that the differential value accurately reflects the difference in the respective model performance attribute values;
selecting, based on the computed confidence interval, the first machine learning model; and
in response to selecting the first machine learning model, obtaining, using the first machine learning model and for a set of actual data items encountered in a production environment, a corresponding set of predicted values for the target attribute.

16. The non-transitory computer readable medium of claim 15, wherein identifying a subset of training data items from among the plurality of training data items, comprises:
randomly sampling the plurality of training data items to obtain the subset of training data items, wherein the subset of training data items include 10% of the plurality of training data items.

17. The non-transitory computer readable medium of claim 15, wherein the ground-truth value for each label in the plurality of labels is specified by a human.

18. The non-transitory computer readable medium of claim 15, further comprising:
generating, for each training data item, a quality score representing a quality of the training data item and the corresponding label; and
applying the quality scores as weights for the linear regression model.

19. The non-transitory computer readable medium of claim 15, wherein the model performance metric includes at least one of the following: precision, recall, true positive rate, or false positive rate.

20. The non-transitory computer readable medium of claim 15, wherein the target attribute is a relevance of search results provided in response to a search query and wherein obtaining, using the first machine learning model and for a set of actual data items encountered in a production environment, a corresponding set of predicted values for the target attribute, comprises:
obtaining, using the first machine learning model and for a first set of search results corresponding to a first query, a relevance score indicating whether the first set of search results is relevant to the first query.
